(19) United States
(12) Patent Application Publication
(10) Pub. No.: US 2024/0304853 A1
(43) Pub. Date: Sep. 12, 2024

(54) ALL-SOLID-STATE BATTERY PACK

(71) Applicant: TOYOTA JIDOSHA KABUSHIKI KAISHA, Toyota-shi (JP)

(72) Inventor: Yasumasa OGUMA, Nagoya-shi (JP)

(73) Assignee: TOYOTA JIDOSHA KABUSHIKI KAISHA, Toyota-shi (JP)

(21) Appl. No.: 18/530,790

(22) Filed: Dec. 6, 2023

(30) Foreign Application Priority Data
Mar. 9, 2023 (JP) 2023-036444

(51) Int. Cl. H01M 10/0562; H01M 10/054; H01M 10/54; H01M 50/138

(52) U.S. Cl. CPC H01M 10/0562; H01M 10/054; H01M 10/54; H01M 50/138; H01M 2300/002

(57) ABSTRACT

The all-solid-state battery pack includes an all-solid-state battery containing a sulfide solid electrolyte, a battery case housing the all-solid-state battery, and a desulfurization unit disposed at a communication port or inside the battery case. The desulfurization unit includes a unit case and a desulfurization agent enclosed in the unit case. The desulfurization agent contains an alumina-based desulfurization agent. The desulfurization unit includes a carbon material enclosed in the unit case.

### CROSS-REFERENCE TO RELATED APPLICATION

This application claims priority to Japanese Patent Application No. 2023-036444 filed on Mar. 9, 2023, incorporated herein by reference in its entirety.

### BACKGROUND

### 1. Technical Field

The present disclosure relates to an all-solid-state battery pack.

### 2. Description of Related Art

In batteries containing a sulfide solid electrolyte, hydrogen sulfide is created by decomposition of the sulfide solid electrolyte. In the field of batteries, there is known technology for rendering harmless the hydrogen sulfide that is created. For example, Japanese Unexamined Patent Application Publication No. 2018-073802 (JP 2018-073802 A) discloses a battery equipped with a hydrogen sulfide removal unit. This hydrogen sulfide removal unit is provided at a communication port of an outer encasement member in which is enclosed a power generation element. Also, Japanese Unexamined Patent Application Publication No. 2022-167149 (JP 2022-167149 A) discloses a battery pack in which an adsorbent that adsorbs hydrogen sulfide gas is disposed. This adsorbent is disposed at a bottom of a battery case in which is enclosed an all-solid-state battery. Further, Japanese Unexamined Patent Application Publication No. 2009-023869 (JP 2009-023869 A) discloses a desulfurizer equipped with a pressing device that presses and supports a desulfurization agent in a container in a vertical direction.

### SUMMARY

In a desulfurization unit, vibrations cause desulfurization agent bodies to come into contact with each other and generate fine powder. Additionally, vibrations create gaps between the desulfurization agent bodies and a container. There is a problem that desulfurization performance deteriorates due to such factors. In JP 2009-023869 A, the gaps are eliminated by pressing the desulfurization agent with the pressing device. However, in JP 2009-023869 A, space is required to provide the pressing device, and there are problems such as increased weight of the battery pack, the structure of the battery pack becoming complicated, and so forth. Further, in JP 2018-073802 A and JP 2022-167149 A, the problem regarding vibration is not solved.

The present disclosure has been made in view of the above circumstances, and a primary object thereof is to provide an all-solid-state battery pack that is capable of maintaining high desulfurization performance of the desulfurization agent.

In order to solve the above issues, in the present disclosure, an all-solid-state battery pack includes:
an all-solid-state battery containing a sulfide solid electrolyte,
a battery case that houses the all-solid-state battery, and
a desulfurization unit disposed at a communication port of or inside of the battery case.

The desulfurization unit includes a unit case and a desulfurization agent enclosed in the unit case. The desulfurization agent contains an alumina-based desulfurization agent. The desulfurization unit includes a carbon material enclosed in the unit case.

According to the present disclosure, the all-solid-state battery pack capable of maintaining high desulfurization performance of a desulfurization agent can be provided.

The carbon material may be a carbon-based desulfurization agent.

In the above disclosure, a ratio of the alumina-based desulfurization agent to a total of the alumina-based desulfurization agent and the carbon material may be no less than 50 vol %.

In the above disclosure, a ratio of the alumina-based desulfurization agent to a total of the alumina-based desulfurization agent and the carbon material may be no less than 70 vol %.

In the above disclosure, the desulfurization unit may include a composite of the alumina-based desulfurization agent and the carbon material.

The all-solid-state battery pack according to the present disclosure has an advantageous effect of being capable of maintaining high desulfurization performance of the desulfurization agent.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an all-solid-state battery pack according to the present disclosure;

FIG. 2 is a schematic cross-sectional view illustrating a desulfurization unit in the present disclosure; and

FIG. 3 is a schematic diagram for explaining the vibration test.

### DETAILED DESCRIPTION OF EMBODIMENTS

Hereinafter, the all-solid-state battery pack in the present disclosure will be described in detail.

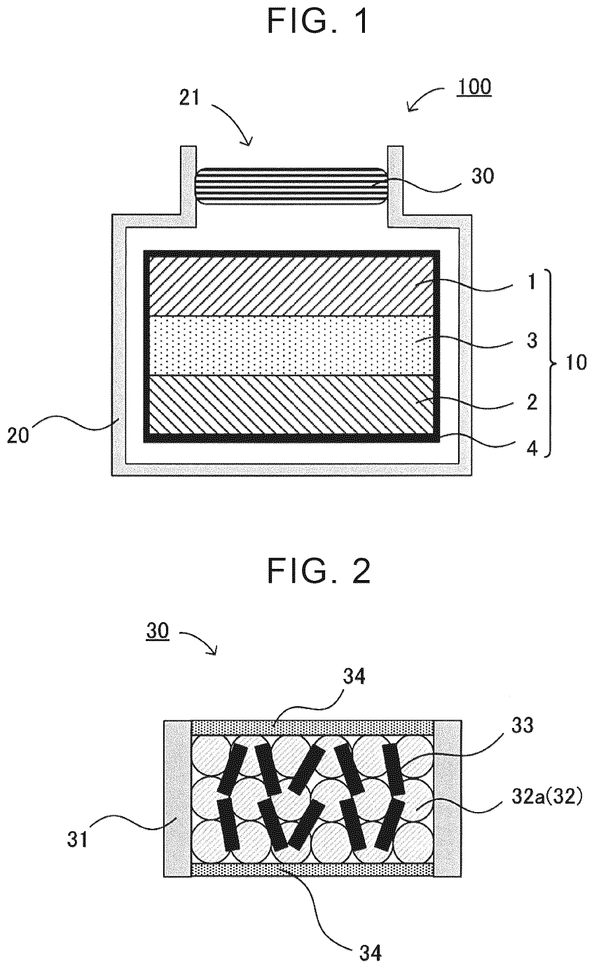

FIG. 1 is a schematic cross-sectional view illustrating an all-solid-state battery pack according to the present disclosure. The all-solid-state battery pack 100 shown in FIG. 1 includes an all-solid-state battery 10, a battery case 20, and a desulfurization unit 30. All-solid-state battery 10 includes a sulfide solid electrolyte. The battery case 20 houses the all-solid-state battery 10. The desulfurization unit 30 is arranged at the communication port 21 of the battery case 20. The all-solid-state battery 10 includes a positive electrode 1, a negative electrode 2, a solid electrolyte layer 3, and a sealing body 4. Solid electrolyte layer 3 is arranged between positive electrode 1 and negative electrode 2. The sealing body 4 seals the positive electrode 1, the negative electrode 2, and the solid electrolyte layer 3. Moreover, at least one of the positive electrode 1, the negative electrode 2, and the solid electrolyte layer 3 contains a sulfide solid electrolyte.

Moreover, FIG. 2 is a schematic cross-sectional view illustrating a desulfurization unit in the present disclosure. The desulfurization unit 30 shown in FIG. 2 includes a unit case 31, a desulfurization agent 32 (alumina-based desulfurization agent 32a) and a carbon material 33 contained in the unit case 31. Furthermore, filters 34 are arranged at the openings on the upper and lower surfaces of the unit case 31. Gas containing hydrogen sulfide is introduced into the unit case 31 through one filter 34. The gas from which hydrogen sulfide has been removed is exhausted from the unit case 31 via the other filter 34.

In the all-solid-state battery pack of the present disclosure, the desulfurization unit includes a soft carbon material. Therefore, it is possible to suppress the desulfurization agent from becoming powdered due to vibration, and the desulfurization performance of the desulfurization agent can be maintained at a high level.

When filling a unit case with a desulfurization agent, it is difficult to fill the unit case so densely that there are no voids. Therefore, the desulfurization agent moves due to vibrations of a vehicle or the like in which the desulfurization unit is mounted, and particles of the desulfurization agent repeatedly collide with each other, resulting in damage. Furthermore, a material with relatively low strength, such as a porous material, is used as the desulfurization agent. Therefore, the desulfurization agent with lower strength is preferentially damaged by collision with the harder unit case. If the desulfurization agent is damaged and pulverized, problems such as a decrease in the ability of the desulfurization agent to adsorb hydrogen sulfide may occur.

On the other hand, in the present disclosure, the desulfurization unit includes an alumina-based desulfurization agent as the desulfurization agent. The desulfurization unit further includes carbon material. Carbon materials are softer than alumina-based desulfurization agents. Therefore, by the carbon material functioning as a cushion, it is possible to suppress the alumina-based desulfurization agent from becoming a fine powder.

The all-solid-state battery pack in the present disclosure includes an all-solid-state battery, a battery case, and a desulfurization unit. Each configuration of the all-solid-state battery pack in the present disclosure will be described below.

### 1. Desulfurization Unit

The desulfurization unit in the present disclosure includes a unit case, and a desulfurization agent and carbon material contained in the unit case. Further, the desulfurization agent includes an alumina-based desulfurization agent.

The material of the unit case is, for example, metal, although it is not particularly limited. When the unit case is a metal case, since the metal case is hard, the desulfurization agent is likely to be pulverized by vibration. In contrast, in the present disclosure, by using a carbon material that functions as a cushion, it is possible to suppress the desulfurization agent from being pulverized due to vibration. The metal used for the metal case is not particularly limited as long as it is resistant to hydrogen sulfide. As the metal used for the metal case, stainless steel, for example, can be used from the viewpoint of resistance to vibration. Further, the shape of the unit case is not particularly limited as long as it satisfies the following conditions (1) and (2).
(1) desulfurization agent and carbon material can be held inside the unit case.
(2) Gas can pass through the inside of the unit case.

For example, the unit case has a hollow shape with a circular, oval, or rectangular cross section. Further, the unit case may have a recessed part, a convex part, or a curved part. The unit case may have filters at openings at both ends thereof.

The desulfurization agent in the present disclosure has a function of adsorbing hydrogen sulfide gas and rendering it harmless. It is preferable that the desulfurization agent is, for example, a porous material. The unit case has at least an alumina-based desulfurization agent as a desulfurization agent. The alumina-based desulfurization agent is a desulfurization agent containing at least alumina (Al₂O₃), and preferably contains alumina as a main component. The proportion of alumina in the alumina-based desulfurization agent is, for example, 50 wt % or more, and may be 70 wt % or more.

Sieving was performed using a sieve specified in JIS Z8801, the weight of the alumina-based desulfurization agent remaining on each sieve was measured, a cumulative distribution was created, the particle size of cumulative 10% was D₁₀, and the particle size of cumulative 50% was Let the diameter be D₅₀ and the cumulative particle size of 90% be D₉₀. Further, the particle size D₅₀ is referred to as the average particle size of the 20 alumina-based desulfurization agent. The average particle size of the alumina-based desulfurization agent is, for example, 1.5 mm or more, and may be 2 mm or more. On the other hand, the average particle size of the alumina-based desulfurization agent is, for example, 10 mm or less, may be 6 mm or less, or may be 4 mm or less. Further, the sharpness of the particle size distribution can be expressed as (D₉₀−D₁₀)/D₅₀. The closer (D₉₀−D₁₀)/D₅₀ is to 1, the less broad the particle size distribution becomes. (D₉₀−D₁₀)/D₅₀ is, for example, 3 or less, may be 2 or less, or may be 1.5 or less.

The desulfurization unit in the present disclosure includes a carbon material enclosed in a unit case. The carbon material mainly functions as a cushion, and may or may not have a function as a desulfurization agent. Among these, the carbon material is preferably a carbon-based desulfurization agent. This is because hydrogen sulfide can be rendered harmless more effectively. The carbon-based desulfurization agent is preferably an activated carbon-based desulfurization agent. It is preferable that the carbon material has carbon as a main component. The proportion of carbon in the carbon material is, for example, 50 wt % or more, may be 70 wt % or more, or may be 90 wt % or more.

Sieving is performed using sieves specified in JIS Z8801, the weight of the carbon material remaining on each sieve is measured, a cumulative distribution is created, the cumulative 10% particle size is D′₁₀, and the cumulative 50% particle size is D′₅₀, and the cumulative particle size of 90% is D′₉₀. Further, the particle size D′₅₀ is referred to as the average particle size of the carbon material. The average particle size of the carbon material is, for example, 1.5 mm or more, and may be 2 mm or more. On the other hand, the average particle size of the carbon material is, for example, 10 mm or less, may be 6 mm or less, or may be 4 mm or less. Further, the sharpness of the particle size distribution can be expressed as (D′₉₀−D′₁₀)/D′₅₀. The closer (D′₉₀−D′₁₀)/D₅₀ is to 1, the less broad the particle size distribution becomes. (D′₉₀−D′₁₀)/D′₅₀ is, for example, 3 or less, may be 2 or less, or may be 1.5 or less.

The ratio of the alumina-based desulfurization agent to the total of the alumina-based desulfurization agent and the carbon material is, for example, 50 vol % or more, and may be 70 vol % or more. On the other hand, the above ratio of the alumina-based desulfurization agent is, for example, 85 vol % or less.

The desulfurization unit may include a composite of an alumina-based desulfurization agent and a carbon material as the desulfurization agent. The above composite is particles in which an alumina component and a carbon component are dispersed. The proportion of the alumina component in the composite is, for example, 15 wt % or more and 40 wt % or less. Further, the proportion of the carbon component in the composite is, for example, 15 wt % or more and 40 wt % or less. In addition to the alumina component and the carbon component, the composite may contain other components such as carbonate and hydrogen carbonate.

Sieving was carried out using a sieve specified in JIS Z8801, the weight of the above composite remaining on each sieve was measured, a cumulative distribution was created, and the cumulative particle size of 10% was D″₁₀, and the cumulative 50% particle size was The particle size is D″₅₀, and the cumulative particle size of 90% is D″₉₀. Further, the particle size D″₅₀ is referred to as the average particle size of the composite. The average particle size of the composite is, for example, 2.5 mm or more, and may be 4 mm or more. On the other hand, the average particle size of the composite is, for example, 10 mm or less, and may be 8 mm or less. Further, the sharpness of the particle size distribution can be expressed as (D″₉₀−D″₁₀)/D″₅₀. The closer (D″₉₀−D″₁₀)/D″₅₀ is to 1, the less broad the particle size distribution becomes. (D″₉₀−D″₁₀)/D″₅₀ is, for example, 3 or less, may be 2 or less, or may be 1.5 or less.

Let FMax be the filling rate of the desulfurization agent when the unit case is most densely packed with the desulfurization agent. Since the desulfurization agent is in the form of particles, it is difficult to set FMax to 100%. In the present disclosure, FMax is, for example, 65 vol % or more and 85 vol % or less. The filling rate of the desulfurization agent in the unit case is usually 0.9 FMax or more, may be 0.95 FMax or more, or may be FMax. Further, the filling rate of the desulfurization agent in the unit case is, for example, 65 vol % or more and 85 vol % or less. Note that FMax is calculated from the volume of the unit case and the apparent volume of the entire desulfurization agent.

The desulfurization unit is arranged in the communication port 21 of the battery case 20, for example, as shown in FIG. 1. Further, although not particularly illustrated, the desulfurization unit may be placed at any position inside the battery case 20. Moreover, it is preferable that the desulfurization unit is disposed inside the battery case 20 and outside the all-solid-state battery. This is because if a desulfurization unit is disposed inside an all-solid-state battery, sealing with a sealing body may become difficult.

### 2. All-Solid-State Battery

The all-solid-state battery in the present disclosure includes a positive electrode, a negative electrode, and a solid electrolyte layer. A solid electrolyte layer is disposed between the positive electrode and the negative electrode. A positive electrode usually has a positive electrode active material layer and a positive electrode current collector. A negative electrode usually has a negative electrode active material layer and a negative electrode current collector. An all-solid-state battery usually has a positive electrode current collector, a positive electrode active material layer, a solid electrolyte layer, a negative electrode active material layer, and a negative electrode current collector in this order in the thickness direction. Furthermore, at least one of the positive electrode active material layer, the solid electrolyte layer, and the negative electrode active material layer contains a sulfide solid electrolyte.

The solid electrolyte layer preferably contains a sulfide solid electrolyte. The sulfide solid electrolyte includes, for example, Li element, X element (X is at least one of P, As, Sb, Si, Ge, Sn, B, Al, Ga, and In), and S element. Examples include solid electrolytes. Moreover, the sulfide solid electrolyte may further contain at least one of an O element and a halogen element. Examples of the halogen element include F element, Cl element, Br element, and I element. The sulfide solid electrolyte may be glass (amorphous) or glass ceramics. Examples of the sulfide solid electrolyte include Li₂S—P₂S₅, Lil-Li₂S—P₂S₅, Lil-LiBr—Li₂S—P₂S₅, Li₂S—SiS₂, Li₂S—GeS₂ and Li₂S—P₂S₅—GeS₂. The solid electrolyte layer may contain a binder. Examples of the binder include rubber binders and fluoride binders.

A positive electrode usually has a positive electrode active material layer and a positive electrode current collector. The positive electrode active material layer contains at least a positive electrode active material, and may further contain at least one of a conductive material, a sulfide solid electrolyte, and a binder. Examples of the positive electrode active material include oxide active material such as LiNi_{1/3}Co_{1/3}Mn_{1/3}O₂.

Examples of the conductive material include carbon material. The sulfide solid electrolyte and binder are the same as described above. Examples of the material for the positive electrode current collector include metals such as aluminum, stainless steel, and nickel. Examples of the shape of the positive electrode current collector include a foil shape. The positive electrode current collector may have a carbon coat layer on the surface on the positive electrode active material layer side.

A negative electrode usually has a negative electrode active material layer and a negative electrode current collector. The negative electrode active material layer contains at least a negative electrode active material, and may further contain at least one of a conductive material, a sulfide solid electrolyte, and a binder. Examples of the negative electrode active material include metal active material such as Li and Si, carbon active material such as graphite, and oxide active material such as Li₄Ti₅O₁₂. The conductive material, sulfide solid electrolyte, and binder are the same as described above. Examples of the material for the negative electrode current collector include metals such as copper, stainless steel, and nickel. Examples of the shape of the negative electrode current collector include a foil shape. The negative electrode current collector may have a carbon coat layer on the surface on the negative electrode active material layer side.

Here, one set of a positive electrode, a negative electrode, and a solid electrolyte layer is referred to as a power generation unit. The all-solid-state battery may have one power generation unit or a plurality of power generation units. When the all-solid-state battery has a plurality of power generation units, they may be connected in series or in parallel. The all-solid-state battery may have a sealing body that seals one or more power generation units. Examples of the sealing body include a laminate film having an inner resin layer, a metal layer, and an outer resin layer in this order in the thickness direction. Examples of the material for the inner resin layer include olefin resins such as polypropylene (PP) and polyethylene (PE). Examples of the material of the metal layer include aluminum, aluminum alloy, and stainless steel. Examples of the material for the outer resin layer include polyethylene terephthalate (PET) and nylon.

The all-solid-state battery may include a restraint jig that applies restraint pressure in the thickness direction to one or more power generation units. As the restraint jig, a known jig can be used. The confining pressure is, for example, 0.1 MPa or more and 50 MPa or less, and may be 1 MPa or more and 20 MPa or less. The all-solid-state battery is, for example, an all-solid lithium ion secondary battery.

### 3. Battery Case

The battery case in the present disclosure is a case that houses the all-solid-state battery described above. The battery case houses one or more all-solid-state batteries. As the material constituting the battery case, materials generally used for battery cases of known all-solid-state battery packs, such as metals and resins, can be used.

The shape of the battery case is not particularly limited as long as it can accommodate an all-solid-state battery, but examples include a square shape. The battery case may have a communication port that allows gas to be exchanged (in and out) between the inside and outside of the battery case. Further, a check valve that suppresses backflow of gas may be disposed on the upstream side or downstream side of the communication port. Furthermore, the desulfurization unit may be placed upstream or downstream of the check valve.

### 4. All-Solid-State Battery Pack

Applications of the all-solid-state battery pack in the present disclosure are not particularly limited, but include power sources of vehicles such as hybrid electric vehicles (HEVs), plug-in hybrid electric vehicles (PHEVs), battery electric vehicles (BEVs), gasoline vehicles, and diesel vehicles. In particular, it is preferably used as a power source for driving a hybrid electric vehicle, a plug-in hybrid electric vehicle, or a battery electric vehicle. Further, the all-solid-state battery pack according to the present disclosure may be used as a power source for a moving body other than a vehicle (for example, a railway, a ship, an aircraft). Furthermore, the all-solid-state battery pack according to the present disclosure may be used as a power source for electrical products such as information processing devices.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

### Example 1

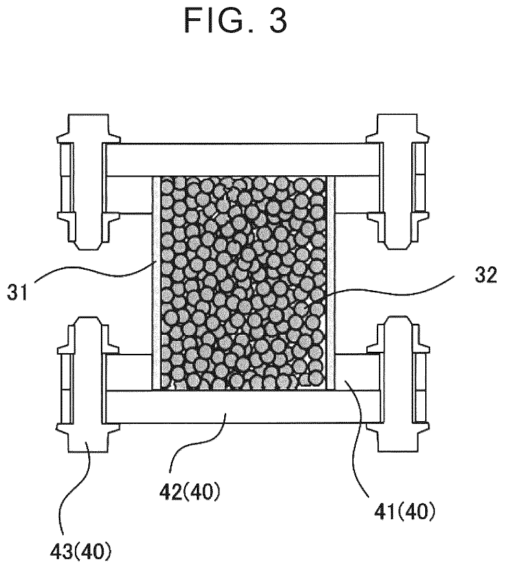

A porous alumina-based desulfurization agent (average particle size: 2.7 mm) and a carbon-based desulfurization agent A were filled inside a cylindrical unit case made of stainless steel. The particle size of the porous alumina-based desulfurization agent is adjusted to 2 mm or more and less than 4 mm using a sieve. The base material of carbon-based desulfurization agent A is activated carbon. The average particle size of the carbon-based desulfurization agent A was larger than that of the porous alumina-based desulfurization agent and was 4 mm or less. Furthermore, the proportions of the porous alumina-based desulfurization agent and the carbon-based desulfurization agent A were 70 vol % for the porous alumina-based desulfurization agent and 30 vol % for the carbon-based desulfurization agent A. As illustrated in FIG. 3, the unit case 31 was fixed using a fixing jig 40. Fixing using the fixing jig 40 was performed as follows.
(1) The side surface of the unit case 31 was held between the fixing portions 41.
(2) The upper and lower surfaces of the unit case 31 were held between the plate members 42.
(3) The fixing portions 41 and the plate members 42 were fastened with bolts 43.

A vibration test was conducted in which the unit case, which was fixed by a fixing jig, was vibrated along with the fixing jig. In the vibration test, 2 million cycles of vibration were applied at an acceleration of 5 G and a frequency of 17 Hz. After that, the particle size distribution of the desulfurization agent after the vibration test was measured by sieving the desulfurization agent in the unit case. The weight ratio of desulfurization agent (less than 1 mm) was investigated. The results are shown in Table 1 below.

### Example 2

A vibration test was conducted in the same manner as in Example 1, except that instead of carbon-based desulfurization agent A, which also uses activated carbon as a base material, carbon-based desulfurization agent B, which also uses activated carbon as a base material, was used. Note that the average particle diameter of carbon-based desulfurization agent B was larger than that of carbon-based desulfurization agent A and was 4 mm or less. Thereafter, the desulfurization agent in the unit case was sieved to measure the particle size distribution of the desulfurization agent after the vibration test. Based on this measurement result, the ratio of the weight of the finely powdered desulfurization agent (desulfurization agent with a particle size of less than 1 mm) to the weight of the desulfurization agent filled in the unit case was investigated. The results are shown in Table 1 below.

### Example 3

A vibration test was conducted in the same manner as in Example 1, except that a composite of an alumina-based desulfurization agent and a carbon desulfurization agent whose particle size was adjusted to 4 mm or more and 7 mm or less using a sieve was used as the desulfurization agent. When the above composite was analyzed by SEM-EDX, Al and C were detected at different positions, which confirmed that it was a composite containing an alumina component and a carbon component. Further, the proportion of the alumina component in the composite was about 25 wt %, and the proportion of the carbon component in the composite was about 30 wt %. Moreover, the above-mentioned complex had sodium hydrogen carbonate and potassium carbonate as other components. Thereafter, the desulfurization agent in the unit case was sieved to measure the particle size distribution of the desulfurization agent after the vibration test. Based on the measurement results, the ratio of the weight of the finely powdered desulfurization agent (desulfurization agent with a particle size of less than 1 mm) to the weight of the desulfurization agent filled in the unit case was investigated. The results are shown in Table 1 below.

### Comparative Example 1

A vibration test was conducted in the same manner as in Example 1, except that the carbon-based desulfurization agent A was not used and the deficiency was supplemented with the porous alumina-based desulfurization agent. Thereafter, the desulfurization agent in the unit case was sieved to measure the particle size distribution of the desulfurization agent after the vibration test. Based on the measurement results, the ratio of the weight of the finely powdered desulfurization agent (desulfurization agent with a particle size of less than 1 mm) to the weight of the desulfurization agent filled in the unit case was investigated. The results are shown in Table 1 below.

TABLE 1

| | | Micronization |
|---|---|---|
| | Desulfurization agent | ratio (wt %) |
| Example 1 | Alumina desulfurization agent | 15.8 |
| | Carbon-based desulfurization | |
| | agent A | |
| Example 2 | Alumina desulfurization agent | 17.0 |
| | Carbon-based desulfurization | |
| | agent B | |
| Example 3 | Alumina-carbon composite | 1.0 |
| | desulfurization agent | |
| Comparative | — | 26.5 |
| Example 1 | | |

As shown in Table 1, in Examples 1 to 3 in which the unit case was filled with carbon material (carbon material-based desulfurization agent), it was confirmed that the ratio of the pulverized desulfurization agent was low as compared to Comparative Example 1, and pulverization was suppressed.

What is claimed is:

1. An all-solid-state battery pack, comprising:
an all-solid-state battery containing a sulfide solid electrolyte;
a battery case that houses the all-solid-state battery; and
a desulfurization unit disposed at a communication port of or inside of the battery case, wherein
the desulfurization unit includes a unit case and a desulfurization agent enclosed in the unit case,
the desulfurization agent contains an alumina-based desulfurization agent, and
the desulfurization unit includes a carbon material enclosed in the unit case.

2. The all-solid-state battery pack according to claim 1, wherein the carbon material is a carbon-based desulfurization agent.

3. The all-solid-state battery pack according to claim 1, wherein a ratio of the alumina-based desulfurization agent to a total of the alumina-based desulfurization agent and the carbon material is no less than 50 vol %.

4. The all-solid-state battery pack according to claim 1, wherein a ratio of the alumina-based desulfurization agent to a total of the alumina-based desulfurization agent and the carbon material is no less than 70 vol %.

5. The all-solid-state battery pack according to claim 1, wherein the desulfurization unit includes a composite of the alumina-based desulfurization agent and the carbon material.
